(19) United States
(12) Patent Application Publication
(10) Pub. No.: US 2025/0054099 A1
(43) Pub. Date: Feb. 13, 2025

(54) Increasing Petrophysical Image Log Resolution using Deep Learning Techniques

(71) Applicant: Saudi Arabian Oil Company, Dhahran (SA)

(72) Inventor: Abdullah A. Alakeely, Dhahran (SA)

(21) Appl. No.: 18/366,343

(22) Filed: Aug. 7, 2023

(51) Int. Cl. G06T 3/40; G06T 5/00

(52) U.S. Cl. CPC G06T 3/40; G06T 5/00; G06T 2207/20016; G06T 2207/20081; G06T 2207/30181

(57) ABSTRACT

A computer-implemented method for increasing petrophysical image log resolution using deep learning is described. In examples, a group of images is prepared for training a machine learning model. The machine learning model is trained using the prepared group of images, wherein the machine learning model learns a function that increases a resolution of the prepared group of images. Unseen images are input to the trained machine learning model, wherein the trained machine learning model outputs respective high-resolution images.

### TECHNICAL FIELD

This disclosure relates generally to increasing petrophysical image log resolution using deep learning techniques.

### BACKGROUND

Petrophysical image logs include images of features or structures below the surface of the earth. The petrophysical image logs can include images of a wellbore, reservoir, and other subsurface structures. The captured features or structures are used to determine information such as lithology, sedimentary textures, flow directions, fractures and in situ stress analysis.

### SUMMARY

An embodiment described herein provides a method for increasing petrophysical image log resolution using deep learning techniques. The method includes preparing, using at least one hardware processor, a group of images for training a machine learning model, wherein a respective image of the group of images comprises random image data. The method includes training, using the at least one hardware processor, the machine learning model using the prepared group of images, wherein the machine learning model learns a function that increases a resolution of the prepared group of images. Additionally, the method includes inputting, using the at least one hardware processor, unseen images to the trained machine learning model, wherein the trained machine learning model outputs respective high-resolution images.

An embodiment described herein provides an apparatus comprising a non-transitory, computer readable, storage medium that stores instructions that, when executed by at least one processor, cause the at least one processor to perform operations. The operations include preparing a group of images for training a machine learning model, wherein a respective image of the group of images comprises random image data. The operations also include training the machine learning model using the prepared group of images, wherein the machine learning model learns a function that increases a resolution of the prepared group of images. Additionally, the operations include inputting unseen images to the trained machine learning model, wherein the trained machine learning model outputs respective high-resolution images.

An embodiment described herein provides a system. The system comprises one or more memory modules and one or more hardware processors communicably coupled to the one or more memory modules. The one or more hardware processors is configured to execute instructions stored on the one or more memory models to perform operations. The operations include preparing a group of images for training a machine learning model, wherein a respective image of the group of images comprises random image data. The operations include training the machine learning model using the prepared group of images, wherein the machine learning model learns a function that increases a resolution of the prepared group of images. Additionally, the operations include inputting unseen images to the trained machine learning model, wherein the trained machine learning model outputs respective high-resolution images.

In some embodiments, preparing the group of images for training the machine learning model comprises resizing respective images of the group of images.

In some embodiments, preparing the group of images for training the machine learning model comprises reducing a resolution of respective images of the group of images.

In some embodiments, the trained machine learning model comprises three convolution layers and a reshaping layer.

In some embodiments, the trained machine learning model comprises a reshaping layer that increases a size of the respective high-resolution images to an original size of the unseen images.

In some embodiments, the machine learning model is iteratively trained until a pixel-wise signal to noise ratio of outputs of the trained machine learning model is improved relative to earlier iterations of the trained machine learning model.

In some embodiments, preparing the group of images for training the machine learning model comprises converting the images to greyscale.

### BRIEF DESCRIPTION OF DRAWINGS

FIG. 1 shows data preparation according to the present techniques.

FIG. 2 shows a deep learning model architecture.

FIG. 3 is a process flow diagram of a process for increasing petrophysical image log resolution using deep learning techniques.

FIG. 4 illustrates hydrocarbon production operations that include both one or more field operations and one or more computational operations, which exchange information and control exploration for the production of hydrocarbons.

FIG. 5 is a schematic illustration of an example controller for increasing petrophysical image log resolution using deep learning techniques.

### DETAILED DESCRIPTION

When drilling wells with logging-while-drilling (LWD) tools, the bandwidth limitations of mud-pulse systems that transfer the information to surface during drilling limits the availability of high-resolution data for surface applications in real-time. High-resolution images are not transferred to the surface using mud-pulse systems due to the bandwidth limitations. In examples, density image logs are available in low-resolution format during drilling. The low-resolution data is inadequate for various real-time surface applications, such as thin-bed analysis. Thus, lower-resolution images obtained during drilling are of less value when making decisions in surface applications concurrently with drilling.

The ability to utilize high-resolution images in real-time while drilling enables a reduction in the uncertainty associated with surface applications such as geo-steering. Further, the ability to utilize high-resolution images in real-time while drilling improves the efficiency of LWD decision making processes. The present techniques use deep learning algorithms to improve the resolution of real-time data while drilling, before memory data (e.g., high resolution data stored in memory of downhole tools) is available. The present techniques output high-resolution log data from low-resolution log data in real-time. This enables accurate data for decision-making processes during drilling and reduces the time needed to make decisions based on memory data. Additionally, the present techniques enable more accurate and robust surface applications, such as geo-steering, thin-bed analysis, the identification of bed boundaries, and the identification of formation features in real-time. The present techniques improve well completion practices due to accurate and precise identification of pay zones in real-time.

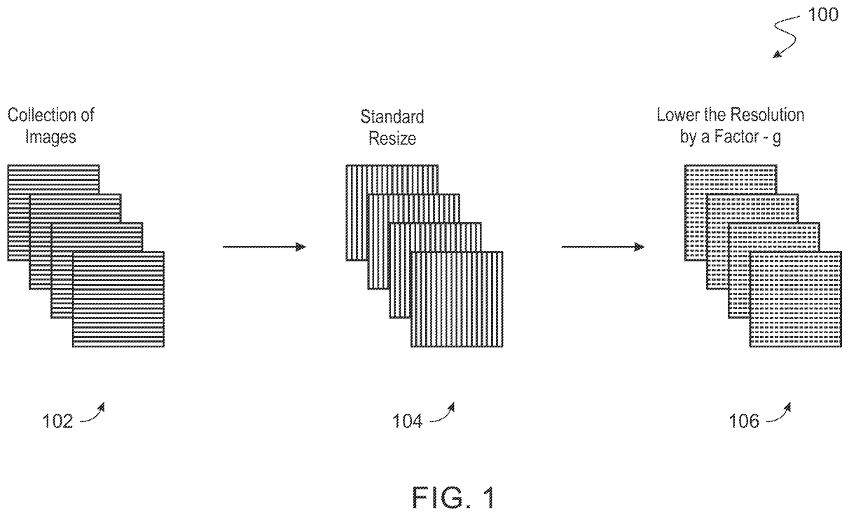

FIG. 1 shows data preparation according to the present techniques. In examples, the data is prepared for use with deep learning techniques.

As shown in FIG. 1, a group of images is obtained to generate training data. At block 102, random image data is collected. In examples, each image of the group of images includes random image data. As described herein, random image data is a collection of images taken from an environment without specificity. In some embodiments, the images are taken from random environments, and the machine learning model is trained by learning a mapping function that transforms the images from a low-resolution to a high-resolution. By using random images, the present techniques are not restricted to log data, which can be scarce. In examples, the learned function of any random collection of images is applied to the log data.

In examples, low-resolution images lack fine details that enable the execution of surface applications. For example, low-resolution images are sparse and include fewer data points when compared to high-resolution images. In examples, compared to a high-resolution image, low-resolution images have fewer pixels, higher compression, or both. In examples, high-resolution images include details that enable the execution of surface applications.

At block 104, the images are preprocessed by standardizing a size of the images and amount of color channels in the images. For example, the images are converted to a size corresponding to an input image size of a machine learning model. In examples, standardizing the color channels includes converting the images to grayscale. By reducing the number of color channels from 3 in colored images to 1 in grayscale images, training the machine learning model is made faster and more efficient compared to training using more than a single color channel.

At block 106, the resolution of the images on both dimensions is reduced by a factor of g. In some embodiments, the image resolution is reduced by applying the factor and also using bicubic interpolation. In examples, the factor g is selected to be around 3 to 6. The data preparation performed at blocks 102-106 results in training data comprising low resolution images. In some embodiments, the data preparation 100 is performed using analysis software, such as Python.

After data preparation, a deep learning algorithm is trained to transform the prepared low-resolution images (e.g., training data) to high-resolution images. In examples, a machine learning model learns a mapping function from the training images. The machine learning model executes the learned function on unseen log data, i.e., density image data. This enables the availability of high-resolution images in real-time for decision making. In addition, the present techniques reduce the uncertainty in geo-steering as high-resolution images are available during drilling and when a decision is needed.

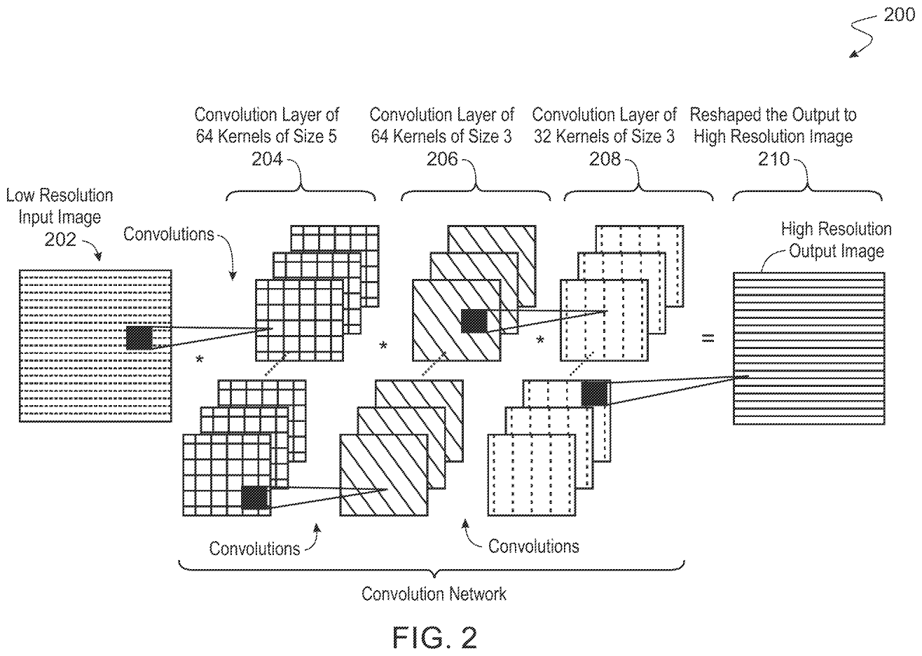

FIG. 2 shows a deep learning model architecture 200. The trained model 200 acts as learned function that takes as input low-resolution input images (x), and transforms the images to high-resolution output images (y). The following equation describes the learned function:

$$f ( x ) = y , \qquad Eqn . 1$$

In the example of FIG. 2, the trained model 200 corresponds to a learned function that is a convolutional neural network with three transformation layers and one output layer. A low-resolution input image (x) 202 is input to the trained model 200. In examples, the low-resolution input image (x) 202 is obtained from unseen petrophysical log data. In particular, low-resolution input image (x) 202 is an element of a set of unseen images (R). The set of unseen images have a resolution of m×n. During data preparation, as described with respect to FIG. 1, the resolution of the set of random images is lowered by a factor of g as follows:

$$x ∈ {R}^{( \frac{m}{g} ) \times ( \frac{n}{g} )} \qquad Eqn . 2$$

The model 200 includes convolutional layers 204, 206, and 208. The first convolutional layer 204 is a convolutional layer of 64 kernels, each of size=5, stride of 1, using a same padding and followed by a rectified linear unit (RELU) activation function. The second convolutional layer 206 is a convolutional layer of 64 kernels, each of size=3, stride of 1, using a same padding and followed by RELU activation function. The third convolutional layer is a convolutional layer of 32 kernels, each of size=3, stride of 1, using a same padding and followed by RELU activation function. In examples, a same padding refers to the fact that the convolutional layer does not down sample the output volume/area after applying the filter. Padding is applied around the output to keep the size of each respective output volume the same.

As shown in FIG. 2, a reshaping layer 210 is a layer that reshapes the third convolutional layer output to the correct size of output, a high-resolution image of size, y∈R^{m×n}. In examples, the model is trained with an optimization algorithm, such as a gradient descent algorithm, to fine tune the model parameters. In examples, training data is used to train the machine learning model over time, and a cost function acts as a barometer that gauges the accuracy of the trained model with each iteration of parameter updates.

In examples, the performance of the model is evaluated based on Pixel-wise Signal to Noise Ratio (PSNR), as follows:

$$PSNR = 20 {log}_{10} ( \frac{{MAX}_{f}}{\sqrt{MSE}} ) \qquad Eqn . 3$$

Where:

$$MSE = \frac{1}{mn} {\sum }_{0}^{m - 1} {\sum }_{0}^{n - 1} {‖ f ( i , j ) - b ( i , j ) ‖}^{2} \qquad Eqn . 4$$

The MSE calculates the average of the squared differences between the predicted values and the actual values. A lower MSE means that the predictions are closer to the actual values. Additionally, with respect to Equations 2 and 3, f is matrix data (e.g., pixel data of the image arranged in a matrix format) of the original image; b is matrix data of the degraded image; m represents the number of rows of pixels of the images, where i represents the index of the row; n represents the number of columns of pixels of the images, where i represents the index of the column; and MAX_{f} is the maximum signal value that exists in the original known to be good image. In examples, the model 200 improves PSNR. For example, a PSNR of an original image is 77.1, and the PSNR after applying increasing the resolution is 78.25. Accordingly, the present techniques improve image resolution, in real time, without the use of filtering or interpolation of missing data in addition to density calculations. Further, the present techniques increase the resolution of the images, instead of simply increasing the size of the images. According to the present techniques, a relationship between low resolution images and high-resolution images is determined automatically using deep learning techniques. In addition, the determined relationship or function is not specific to particular images and can be applied generally to any type of images (e.g., any service provider).

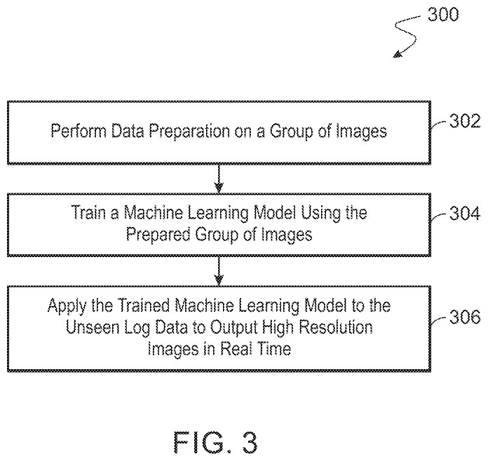

FIG. 3 is a process flow diagram of a process 300 for increasing petrophysical image log resolution using deep learning techniques.

At block 302, data preparation is performed using a group of images. The group of images comprise random image data that is preprocessed and downscaled (e.g., reduce the size of the image on both dimensions) to lower the resolution of the group of images. In some embodiments, the data preparation is performed as described with respect to FIG. 1.

At block 304, a model is trained using the prepared group of images. In examples, the model represents a learned function. Additionally, in examples the model includes three convolutional layers and one reshaping layer. In some embodiments, the model is the trained machine learning model as described with respect to FIG. 2.

At block 306, the trained machine learning model is applied to unseen log data (e.g., low resolution images), and the trained machine learning model outputs high resolution images corresponding to the low-resolution images. During drilling, low resolution image log data is streamed in array form for processing and input to the trained machine learning model. The trained machine learning model outputs corresponding high-resolution images. Accordingly, the present techniques provide high-resolution images during drilling without accessing the images stored on in memory present on downhole LWD tools.

In some embodiments, performance of the trained machine learning model is evaluated prior to applying the trained machine learning model to unseen log data. The trained machine learning model is iteratively retrained until the PSNR of the model is improved relative to earlier iterations of the trained machine learning model. In examples, both training and validation loss is evaluated, and training stops if there is no further improvement.

The trained machine learning model according to the present techniques improves the resolution of LWD image data in operation without waiting for memory data, improve efficiency of operations, resolve bed boundaries better in real-time. The real time decisions minimize the potential of missing targets, improve the decision cycle, and save time and money by having real-time data in high resolution.

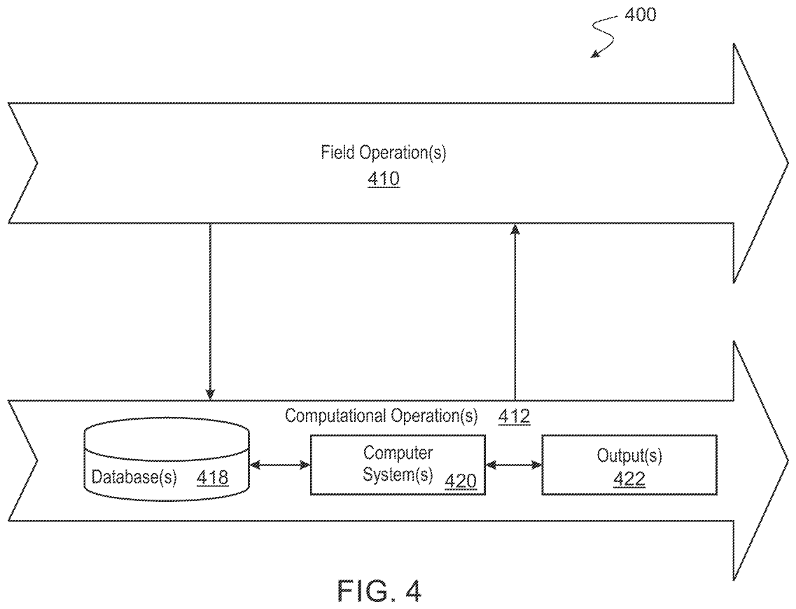

FIG. 4 illustrates hydrocarbon production operations 400 that include both one or more field operations 410 and one or more computational operations 412, which exchange information and control exploration for the production of hydrocarbons. In some implementations, outputs of techniques of the present disclosure can be performed before, during, or in combination with the hydrocarbon production operations 400, specifically, for example, either as field operations 410 or computational operations 412, or both.

Examples of field operations 410 include forming/drilling a wellbore, hydraulic fracturing, producing through the wellbore, injecting fluids (such as water) through the wellbore, to name a few. In some implementations, methods of the present disclosure can trigger or control the field operations 410. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 410 and responsively triggering the field operations 410 including, for example, generating plans and signals that provide feedback to and control physical components of the field operations 410. Alternatively, or in addition, the field operations 410 can trigger the methods of the present disclosure. For example, implementing physical components (including, for example, hardware, such as sensors) deployed in the field operations 410 can generate plans and signals that can be provided as input or feedback (or both) to the methods of the present disclosure.

Examples of computational operations 412 include one or more computer systems 420 that include one or more processors and computer-readable media (e.g., non-transitory computer-readable media) operatively coupled to the one or more processors to execute computer operations to perform the methods of the present disclosure. The computational operations 412 can be implemented using one or more databases 418, which store data received from the field operations 410 and/or generated internally within the computational operations 412 (e.g., by implementing the methods of the present disclosure) or both. For example, the one or more computer systems 420 process inputs from the field operations 410 to assess conditions in the physical world, the outputs of which are stored in the databases 418. For example, seismic sensors of the field operations 410 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 412 where they are stored in the databases 418 and analyzed by the one or more computer systems 420.

In some implementations, one or more outputs 422 generated by the one or more computer systems 420 can be provided as feedback/input to the field operations 410 (either as direct input or stored in the databases 418). The field operations 410 can use the feedback/input to control physical components used to perform the field operations 410 in the real world.

For example, the computational operations 412 can process the seismic data to generate three-dimensional (3D) maps of the subsurface formation. The computational operations 412 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 412 to process new information about the formation and control the drilling to adjust to the observed conditions in real-time.

The one or more computer systems 420 can update the 3D maps of the subsurface formation as information from one exploration well is received and the computational operations 412 can adjust the location of the next exploration well based on the updated 3D maps. Similarly, the data received from production operations can be used by the computational operations 412 to control components of the production operations. For example, production well and pipeline data can be analyzed to predict slugging in pipelines leading to a refinery and the computational operations 412 can control machine operated valves upstream of the refinery to reduce the likelihood of plant disruptions that run the risk of taking the plant offline.

In some implementations of the computational operations 412, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 4 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

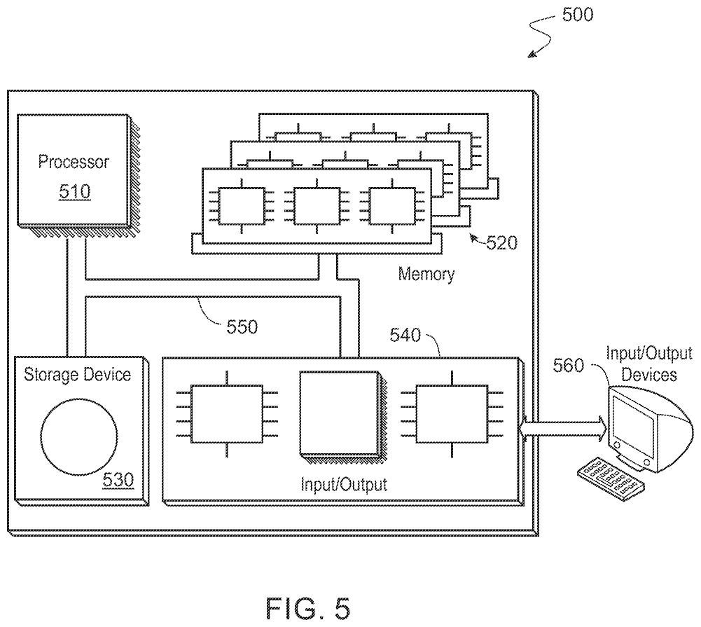

FIG. 5 is a schematic illustration of an example controller 500 (or control system) for increasing petrophysical image log resolution using deep learning techniques. For example, the controller 500 may be operable according to the process 300 of FIG. 3. The controller 500 is intended to include various forms of digital computers, such as printed circuit boards (PCB), processors, digital circuitry, or otherwise parts of a system for supply chain alert management. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 500 includes a processor 510, a memory 520, a storage device 530, and an input/output interface 540 communicatively coupled with input/output devices 560 (for example, displays, keyboards, measurement devices, sensors, valves, pumps). Each of the components 510, 520, 530, and 540 are interconnected using a system bus 550. The processor 510 is capable of processing instructions for execution within the controller 500. The processor may be designed using any of a number of architectures. For example, the processor 510 may be a CISC (Complex Instruction Set Computers) processor, a RISC (Reduced Instruction Set Computer) processor, or a MISC (Minimal Instruction Set Computer) processor.

In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output interface 540.

The memory 520 stores information within the controller 500. In one implementation, the memory 520 is a computer-readable medium. In one implementation, the memory 520 is a volatile memory unit. In another implementation, the memory 520 is a nonvolatile memory unit.

The storage device 530 is capable of providing mass storage for the controller 500. In one implementation, the storage device 530 is a computer-readable medium. In various different implementations, the storage device 530 may be a floppy disk device, a hard disk device, an optical disk device, or a tape device.

The input/output interface 540 provides input/output operations for the controller 500. In one implementation, the input/output devices 560 includes a keyboard and/or pointing device. In another implementation, the input/output devices 560 includes a display unit for displaying graphical user interfaces.

There can be any number of controllers 500 associated with, or external to, a computer system containing controller 500, with each controller 500 communicating over a network. Further, the terms “client,” “user,” and other appropriate terminology can be used interchangeably, as appropriate, without departing from the scope of the present disclosure. Moreover, the present disclosure contemplates that many users can use one controller 500 and one user can use multiple controllers 500.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/-R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer-implemented method for increasing petrophysical image log resolution, the method comprising:
preparing, using at least one hardware processor, a group of images for training a machine learning model, wherein a respective image of the group of images comprises random image data;
training, using the at least one hardware processor, the machine learning model using the prepared group of images, wherein the machine learning model learns a function that increases a resolution of the prepared group of images; and
inputting, using the at least one hardware processor, unseen images to the trained machine learning model, wherein the trained machine learning model outputs respective high-resolution images.

2. The computer-implemented method of claim 1, wherein preparing the group of images for training the machine learning model comprises resizing respective images of the group of images.

3. The computer-implemented method of claim 1, wherein preparing the group of images for training the machine learning model comprises reducing a resolution of respective images of the group of images.

4. The computer-implemented method of claim 1, wherein the trained machine learning model comprises three convolution layers and a reshaping layer.

5. The computer-implemented method of claim 1, wherein the trained machine learning model comprises a reshaping layer that increases a size of the respective high-resolution images to an original size of the unseen images.

6. The computer-implemented method of claim 1, wherein the machine learning model is iteratively trained until a pixel-wise signal to noise ratio of outputs of the trained machine learning model is improved relative to earlier iterations of the trained machine learning model.

7. The computer-implemented method of claim 1, wherein preparing the group of images for training the machine learning model comprises converting the images to greyscale.

8. An apparatus comprising a non-transitory, computer readable, storage medium that stores instructions that, when executed by at least one processor, cause the at least one processor to perform operations comprising:
preparing a group of images for training a machine learning model, wherein a respective image of the group of images comprises random image data;
training the machine learning model using the prepared group of images, wherein the machine learning model learns a function that increases a resolution of the prepared group of images; and
inputting unseen images to the trained machine learning model, wherein the trained machine learning model outputs respective high-resolution images.

9. The apparatus of claim 8, wherein preparing the group of images for training the machine learning model comprises resizing respective images of the group of images.

10. The apparatus of claim 8, wherein preparing the group of images for training the machine learning model comprises reducing a resolution of respective images of the group of images.

11. The apparatus of claim 8, wherein the trained machine learning model comprises three convolution layers and a reshaping layer.

12. The apparatus of claim 8, wherein the trained machine learning model comprises a reshaping layer that increases a size of the respective high-resolution images to an original size of the unseen images.

13. The apparatus of claim 8, wherein the machine learning model is iteratively trained until a pixel-wise signal to noise ratio of outputs of the trained machine learning model is improved relative to earlier iterations of the trained machine learning model.

14. The apparatus of claim 8, wherein preparing the group of images for training the machine learning model comprises converting the images to greyscale.

15. A system, comprising:
one or more memory modules;
one or more hardware processors communicably coupled to the one or more memory modules, the one or more hardware processors configured to execute instructions stored on the one or more memory models to perform operations comprising:
preparing a group of images for training a machine learning model, wherein a respective image of the group of images comprises random image data;
training the machine learning model using the prepared group of images, wherein the machine learning model learns a function that increases a resolution of the prepared group of images; and
inputting unseen images to the trained machine learning model, wherein the trained machine learning model outputs respective high-resolution images.

16. The system of claim 15, wherein preparing the group of images for training the machine learning model comprises resizing respective images of the group of images.

17. The system of claim 15, wherein preparing the group of images for training the machine learning model comprises reducing a resolution of respective images of the group of images.

18. The system of claim 15, wherein the trained machine learning model comprises three convolution layers and a reshaping layer.

19. The system of claim 15, wherein the trained machine learning model comprises a reshaping layer that increases a size of the respective high-resolution images to an original size of the unseen images.

20. The system of claim 15, wherein the machine learning model is iteratively trained until a pixel-wise signal to noise ratio of outputs of the trained machine learning model is improved relative to earlier iterations of the trained machine learning model.
